(19) United States
(12) Patent Application Publication
(10) Pub. No.: US 2002/0069851 A1
(43) Pub. Date: Jun. 13, 2002

(54) Method for improving the response relationship of an exhaust gas turbo charger of an internal combustion engine

(76) Inventors: Andreas Doring, Nurnberg (DE); Reinhard Lammermann, Stein (DE); Hans Sauter, Nurnberg (DE)

Correspondence Address: ROBERT W. BECKER & ASSOCIATES, Suite B, 11896 N. Highway 14, Tijeras, NM, 87058, US

(21) Appl. No.: 10/021,775

(22) Filed: Dec. 12, 2001

(30) Foreign Application Priority Data
Dec. 12, 2000 (DE) 100 61 796.4

(51) Int. Cl. F02B 3/00

(52) U.S. Cl. 123/299

(57) ABSTRACT

A method for improving the response relationship of an exhaust gas turbo charger during intermittent operation of a combustion engine having compressed air includes injecting a follow on injection after a principal injection. During a positive load change, an idling operation, or a partial load operation, the follow on injection is delayed to a relatively late time point such that a complete vaporization of the combustion fuel in the cylinder is accomplished without effecting as well a combustion of the mixture of combustion fuel vapor and oxygen remainder of the exhaust gas in the cylinder. The mixture of combustion fuel vapor and exhaust gas is oxidized first upon passage of the mixture through an exhaust gas handling component between the outlet valve and the inlet of an exhaust gas turbine of an exhaust gas turbo charger.

### BACKGROUND OF THE INVENTION

The present invention relates to a method for improving the response relationship of an exhaust gas turbo charger of an internal combustion engine.

EP 0 621 400 B1 discloses a device for injecting fuel into a diesel internal combustion engine having a Common Rail injection system divided into a primary and secondary injection. The secondary injection is accomplished in a manner such that the combustible fuel still continues to combust and such that, via the combustion during the expansion phase, the exhaust gas temperature increases. As a result of the raised exhaust gas temperature, a catalyzer located in the exhaust gas system is rapidly warmed up from a cold condition so as to thereby be relatively more rapidly placed in its activated condition for reducing the concentration of the hydrocarbon portion and the NOₓ.

DE 30 46 876 C2 discloses an internal combustion engine having a turbo charger whereby, to accelerate the exhaust gas turbo charger, the exhaust gas turbine of a combustion chamber is actuated ahead of the charging operation. The combustion chamber is provided with compressed air from the compressor of the exhaust gas turbo charger. During ramping up operation of the internal combustion engine to its normal running operation, fuel is injected into the combustion chamber so that the temperature and enthalpy of the exhaust gas is increased. The exhaust gas turbine, which is actuated after the combustion operation in the combustion chamber, is thereby brought up to its normal running condition in a more rapid manner. Via a feedback effect, the internal combustion engine is, in any event, improved in its response relationship. Such an arrangement, however, requires a high configuration effort, which cannot be realistically provided with respect to typical utility or commercial vehicles.

### SUMMARY OF THE INVENTION

The present invention offers a solution to the challenge of providing a method for improving the responsive relationship of a turbo charger and the thereto-coupled engine in a significant manner without significantly increasing the construction or manufacturing effort.

Due to an increase in the exhaust gas pressure and a simultaneous increase in the exhaust gas enthalpy as a result of the temperature increase, the inventive method promotes a clear increase in the acceleration of the exhaust gas turbo charger. Via a feedback coupling effect, the response relationship of the combustion engine coupled with the exhaust gas turbo charger is improved. The inventive method, additionally, does not require any intervention in the construction of the combustion engine itself. Instead, it is much more the case that only an alteration or intervention in the software of the electronic motor management program is required in order to control the time point of the subsequent injection such that a vaporization of the combustion fuel is effected without such vaporization or combustion occurring in the cylinder. This can be effected in a problem-free manner by use of a Common Rail injection system.

### DETAILED DESCRIPTION OF THE PREFERRED EMBODIMENT

In accordance with the present invention, a catalyzer is recommended as the means for oxidizing the mixture of the combustion fuel vapor and the oxygen remainder portion which is contained in the exhaust gas, the catalyzer being disposed downstream of the output valve yet upstream of the turbine of the charger. The catalyzer can be configured such that, in addition to its oxidation capacity for Hg and CO, the catalyzer also possesses a potential for reducing NOₓ.

With respect to charged diesel internal combustion engines, a problem exists in the response relationship of the exhaust gas turbo charger and the thereto-coupled combustion engine. As a result of their high power density and their favorable working efficiency, charged or loaded combustion engines are deployed in a wide range of uses which require high performance and cost effectiveness with a relatively small space requirement. Thus, above all, such engines have found use in motor vehicle applications and, especially, in diesel powered applications. The problem which exists, however, with respect to motor vehicles, is the pronounced intermittent operation of the motor. This produces above all problems with the acceleration process: since the turbo charger does not yet have access to the energy which it requires for the compressor on the suction side, due to the non-availability of the exhaust gas, the operation leads to a so-called diesel hole; that is, the motor has, at that moment, insufficient air available such that the air ratio lambda abruptly declines and the fuel is no longer completely combusted. In addition to the extended fall off in performance, there exists with the short-term too low of an air ratio—especially with respect to diesel motors—the undesired side effect of soot impact. The inventive method provides a solution to these problems through an increase in the gas energy. Current injector systems such as the Common Rail injection systems, guarantee a uniformly high injection pressure over the entire working stroke of the cylinder, electronic freely selectable injection time points, and differing injections. These possibilities are put to good advantage in that, in accordance with the present invention, following the principal injection, a second, very late follow on injection is performed. Typically, a follow on injection is used in order to oxidize, via the combustion resulting from the follow on injection, the soot particles which are built up during the principal injection thereby reducing particle emissions. In order to guarantee combustion of the drops of combustion fuel and to ensure their complete combustion, the point in time for the follow on injection is, in this connection, typically selected to be, at the latest, 20° degrees after the end of the principal injection. Later injection time points up to around 90° degrees after dead center increase the soot emissions rapidly, due to the incomplete combustion of the injected combustion fuel drops.

It is in this connection that the basic concept of the present invention provides a solution. If one is to select the time point of the follow on injection to be still later—thus, shortly before or even after the opening of the outlet or exhaust valve—there is no longer any combustion of the combustion fuel drops. It is much more the case that there occurs in the cylinder itself a vaporization as well as a formation of a homogeneous mixture of exhaust gas and combustion fuel vapor. The exhaust of a diesel motor still comprises sufficient oxygen for oxidation. Due to the oxidation of the mixtures on the surfaces of a catalyzer during the exhaust stroke, the exhaust gas temperature and, as well, the exhaust gas pressure increase rapidly, both of which produce a higher exhaust gas energy which benefits the turbo charger in this manner: the charging pressure and the air relationship increase significantly. In connection with the homogeneous after burning, the particle as well as the NOₓ emissions sink to a value below the respective particle and NOₓ emissions values obtained by operating according to a method which does not include the extremely late follow on injection.

The true advantage of the method of the present invention can be most clearly seen, however, in connection with intermittent motor operation: since the acceleration phase has already made available a higher loading pressure, the air relationship does not drop off as strongly and the soot impact is thereby clearly diminished. The combustion engine thus more quickly reaches the desired high load point.

In order to avoid increased fuel consumption, the homogeneous after oxidation is only activated when it is required—that is, if soot impact is to be expected due to a positive load intervention or introduction. With respect to small turbo chargers, which are relatively more rapidly responsive, it is sufficient to only activate the follow on injection if a sudden load demand is placed on the combination. With respect to larger and, thereby, more substantially supportive turbo chargers, it makes sense that the follow on injection is constantly executed during idling and/or partial loading such that, in connection with a sudden load introduction, the higher turbo charger revolutions are already available as the engine response to the load introduction commences. The problem which can occur by implementation of the very late follow on injection is that, during a long weak or partial load phase such as, for example, during city driving, or in exhaust operation, the exhaust temperatures drop or sink very rapidly and are no longer sufficient to oxidize the gas mixture. In this connection, the exhaust gas temperatures should be sensed and the actuation of the homogeneous after oxidation should be controlled not only in dependence upon, or as a function of, the load point and/or the changes in the engine loading but, also, should be controlled in dependence upon the exhaust gas temperature. With respect to an exhaust gas temperature which is too low, an actuation of a follow on injection does not make sense as, in this situation, no oxidation of the injected carbon dioxide occurs anymore and this leads to an increase in the hydrocarbon emissions. In order to lower the start-up temperature, surfaces are provided in the series of exhaust gas components at a location upstream of the exhaust gas turbo charger, these surfaces possessing the capacity to oxidize hydrocarbons and carbon monoxide. These can, for example, be comprised of metallic catalyzer supports having a surface comprised of mixed oxides of the components A1₂O₃, TiO₂, WO₃, V₂O₅, SiO₂, or zeolites. Also, elements of the platinum group as well as cerium and zircon, possess a high capacity for oxidizing hydrocarbons. In order to further reduce the NOₓ emissions, NOₓ capture and retaining catalyzers can be arranged upstream of the turbo charger which, due to the high temperatures, can easily be regenerated. At the same time, it is possible to provide the exhaust gas-contacted portions of the exhaust gas series such as the inner surfaces of the cylinder head, the exhaust gas collector, the compressor housing as well as the valves, the valve shafts, and the compressor rotor, with a catalytically active coating for oxidizing hydrocarbons. Through these measures, the hydrocarbons are not only oxidized in a homogeneous gas phase reaction but are also oxidized on the catalytically active surfaces as they are heated by the exothermic and heterogeneous reactions. Due to the deployment of the catalyzers, the start-up temperature of the system is reduced from about 280° C. to under 200° C. If the motor is operated in the weakest load range such as, for example, in a passenger car or in a city transport bus, the temperature can drop below the above-noted 200° C.

The control of the method can be effected by electronic control devices. In partial or weak loading, or, respectively, idling operation, the pumping or surging of the exhaust gas turbo charger must be prevented by suitable methods. This can be effected by blowing out the compressed loading air and/or by throttling of the intake or suction air. The implementation steps can, in any event, be used in order to oppose a too strong cooling off of the exhaust gases in the weak or partial load operation. In any event, it can be advisable to effect a monitoring of the rate of rotation of the exhaust gas turbo charger.

The specification incorporates by reference the disclosure of German priority document 100 61 796.4 filed Dec. 12, 2000.

The present invention is, of course, in no way restricted to the specific disclosure of the specification and drawings, but also encompasses any modifications within the scope of the appended claims.

What we claim is:

1. A method for improving the response relationship of an exhaust gas turbo charger during intermittent operation of a combustion engine having compressed air, the combustion engine having an injection system for injecting a principal injection and at least one follow on injection, and both the principal injection and the follow on injection being effected by the same injector, comprising the steps of:
during at least one of a positive load change, an idling operation, and a partial load operation, controlling the follow on injection to be delayed to a relatively late time point such that a complete vaporization of the combustion fuel in the cylinder is accomplished without also effecting a combustion of the mixture of combustion fuel vapor and oxygen remainder of the exhaust gas in the cylinder; and
oxidizing the mixture of combustion fuel vapor and exhaust gas first upon passage of the mixture through an exhaust gas handling component between the outlet valve and the inlet of an exhaust gas turbine of an exhaust gas turbo charger including, in particular, oxidizing the mixture at the location by contact of the mixture with oxidization promoting means.

2. A method according to claim 1, wherein a catalyzer is configured to have the oxidation promoting means and oxidizing the mixture by contact with the catalyzer between the outlet valve and an inlet of the exhaust gas turbine, whereby the mixture is oxidized along the surface of the catalyzer.

3. A method according to claim 1, wherein, to effect catalytic oxidation, active surfaces are provided which comprise a mixed oxide of at least one of the elements aluminum, tungsten, vanadium, silicon, cerium, and zircon.

4. A method according to claim 3, wherein the catalytic active surfaces are comprised of zeolites.

5. A method according to claim 3, wherein the catalytically active surfaces comprise noble metals such as elements of the platinum group.

6. A method according to claim 3, wherein the catalytically active surface comprises a NOₓ retaining capability.

7. A method according to claim 1, wherein those portions of the vehicle which are contacted by the exhaust gas including at least one of the cylinder heads, the exhaust gas collector, the outlet valves, the turbine housing, and the turbine rotors, are provided with a catalytically active layer.

8. A method according to claim 1, wherein heated surfaces are arranged in a series of exhaust gas components upstream of the exhaust gas turbo charger.

9. A method according to claim 1, wherein catalytically active surfaces which are heated are provided for oxidizing the mixture.

10. A method according to claim 1, wherein the function and the operation of the follow on injection is controlled by electronic elements.

11. A method according to claim 1, and further comprising at least one of throttling the suction or intake air and blowing out the loading air.

12. A method according to claim 10, wherein the exhaust gas temperature is controlled.

13. A method according to claim 1, wherein the rate of revolution of the turbo charger is monitored.

14. A method according to claim 1, wherein the exhaust gas temperature is sensed and the injection of the exhaust gas is actuated in dependence upon the sensed exhaust gas temperature.
